(19) United States
(12) Patent Application Publication
(10) Pub. No.: US 2013/0073946 A1
(43) Pub. Date: Mar. 21, 2013

(54) METHOD AND APPARATUS FOR LOADING WEBPAGE CONTENT OF WEBKIT BROWSER

(71) Applicants: Zu-Zhi Kang, Shanghai (CN); Ming-Yong Sun, Shanghai (CN)

(72) Inventors: Zu-Zhi Kang, Shanghai (CN); Ming-Yong Sun, Shanghai (CN)

(73) Assignee: MStar Semiconductor, Inc., Hsinchu County (TW)

(21) Appl. No.: 13/524,486

(22) Filed: Jun. 15, 2012

(30) Foreign Application Priority Data
Sep. 21, 2011 (CN) 201110282015.8

(51) Int. Cl. G06F 17/00

(52) U.S. Cl. 715/234

(57) ABSTRACT

A method applying an apparatus for loading webpage content of a WebKit browser is provided. The method includes steps of: loading content data of a webpage via a network module, parsing content data of the webpage and retrieving a parse result, generating a plurality of nodes of a Document Object Module (DOM) tree according to the parse result until all nodes of the DOM tree are generated, constructing a DOM tree in accordance to the DOM tree nodes, constructing a render tree according to the DOM tree, performing a webpage layout according to the content data of the webpage according to the render tree, obtaining a plurality of render objects via rendering the render tree, and displaying the webpage according to the webpage layout and the render objects.

This application claims the benefit of People's Republic of China Patent Application Serial No. 201110282015.8, filed Sep. 21, 2011, the subject matter of which is incorporated herein by reference in its entirety.

### BACKGROUND OF THE INVENTION

1. Field of the Invention

The present disclosure relates in general to an apparatus for loading webpage content and an associated method, and more particularly to a method and apparatus for loading webpage content of the WebKit browser.

2. Description of Related Art

Accompanied with advancements of Internet technologies, Internet browsers have become prevalent in applications initially from personal computers to current embedded systems including mobile phones, smart phones, personal digital/data assistants (PDA), Pocket personal computers, and digital televisions, to name a few. As the number of applications developed on the basis of a wide variety of browsers increases, webpage content becomes more diversified. However, the time required for loading the rich and complex content of a webpage is also lengthened, such that user inconvenience is resulted by the increased time needed for completely loading or rendering the webpage. Further, for an embedded system, browser applications may be restricted by limitations of hardware. Therefore, browser and web application developers are faced with a challenge which relates to being capable of quickly loading webpage content to satisfy user needs and enhance user experience.

WebKit is an open source webpage browser layout engine, and is advantaged by having fast speed, high stability, and good compatibility. Thus, WebKit is popular in various applications and is one of three current dominant browser cores. FIG. 1 shows a schematic diagram of a conventional method of loading webpage content using a WebKit browser engine. In the conventional method, a network module first sends out a data request to a server, and response data from the server is received. According to HTML syntax, data is parsed to construct a document object model (DOM) tree and a render tree at the same time. Through layout and render processes, the webpage is then presented to a viewer.

As previously stated, in the conventional method, the WebKit browser constructs a render tree while constructing a DOM tree from parsed data. That is, in the conventional method, when generating nodes of a DOM tree, nodes of a corresponding render tree are also generated according to visibilities of elements. Yet, the above approach occupies network resources which slow down not only data transfer speed to the network module but also loading speed of webpage content of the WebKit browser, thereby severely depreciating user experiences during webpage browsing.

### SUMMARY OF THE INVENTION

The present disclosure is directed to a method and apparatus for loading webpage content of the WebKit browser, so as to enable the WebKit browser to more quickly process the webpage content to reduce an overall time that the browser needs for loading and rendering a webpage.

According to an aspect the present disclosure, a method of loading webpage content for a WebKit browser is provided. The method includes steps of: downloading content data of a webpage via a network module of the WebKit browser, parsing the webpage content data to obtain a parse result, generating a plurality of nodes of a Document Object Model (DOM) tree according to the parse result, constructing the DOM tree according to the nodes of the DOM tree, constructing a corresponding render tree according to the DOM tree, performing a webpage layout for the webpage content data according to the render tree, performing a webpage rendering for obtaining a render object according to the render tree, and displaying the webpage according to the webpage layout and the render object.

In the method of loading webpage content of the present disclosure, the step of performing the webpage layout for the webpage content data according to the render tree includes: performing the webpage layout for the webpage content data according to the render tree, and sending an inquiry to the network module during a layout process to determine whether the network module is downloading the webpage content data; and continuing parsing the webpage content data and generating the nodes of the DOM tree when it is determined that the network module is downloading the webpage content data until all the nodes contained by the DOM tree are generated.

In the method of loading webpage content of the present disclosure, the step of sending the inquiry during the render process and determining whether the network module is downloading the webpage content data includes: sending the inquiry to the network module each time a layout is completed, and determining whether the network module is downloading the webpage content data.

In the method of loading webpage content of the present disclosure, the step of performing the webpage layout for the webpage content data according to the render tree includes: performing the webpage layout for the webpage content data according to the render tree, and sending an inquiry to the network module during the layout process to determine whether the network module is downloading the webpage content data; and performing the layout process for next webpage content data when it is determined that the network module is not downloading the webpage content data.

In the method of loading webpage content of the present disclosure, the step of sending the inquiry during the render process and determining whether the network module is downloading the webpage content data includes: sending the inquiry to the network module each time layout is completed, and determining whether the network module is downloading the webpage content data.

In the method of loading webpage content of the present disclosure, the step of obtaining the render object via rendering the render tree includes: obtaining the render object via rendering the render tree, sending an inquiry to the network module during the render process to determine whether the network module is downloading the webpage content data; and continuing parsing the webpage content data and generating the nodes of the DOM tree when it is determined that the network module is downloading the webpage content data until all the nodes contained by the DOM tree are generated.

In the method of loading webpage content of the present disclosure, the step of sending the inquiry to the network module during the render process to determine whether the network module is downloading the webpage content data includes: sending the inquiry to the network module each time an object is rendered, and determining whether the network module is downloading the webpage content data.

In the method of loading webpage content of the present disclosure, the step of performing a webpage rendering for obtaining a render object according to the render tree includes: obtaining the render object by performing a webpage rendering according to the render tree, sending an inquiry to the network module during the render process to determine whether the network module is downloading the webpage content data; and rendering a next object when it is determined the network module is not downloading the webpage content data.

In the method of loading webpage content of the present disclosure, the step of sending the inquiry to the network module during the render process to determine whether the network module is downloading the webpage content data includes: sending the inquiry to the network module after an object is rendered, and determining whether the network module is downloading the webpage content data.

In the method of loading webpage content of the present disclosure, the step of downloading the webpage content data includes: sending a request for downloading the webpage content data to a server, and receiving the webpage content data transmitted from the server in response to the request.

According to another aspect of the present disclosure, an apparatus for loading webpage content of a WebKit browser is provided. The apparatus includes: a network module, for performing network data communication between a client with a server; a download module, electrically connected to the network module, for downloading content data of a webpage via the network module; a parse module, electrically connected to the download module, for parsing the webpage content data to obtain a parse result; a first constructing module, electrically connected to the parse module, for generating a plurality of nodes of a DOM tree according to the parse result; a second constructing module, electrically connected to the first constructing module, for constructing the DOM tree according to the nodes of the DOM tree; a third constructing module, electrically connected to the second constructing module, for constructing a corresponding render tree according to the DOM tree; a layout module, electrically connected to the third constructing module, for performing a webpage layout according to the render tree; a render module, electrically connected to the third constructing module, for performing a webpage rendering according to the render tree to obtain a plurality of render objects; and a display module, electrically connected to the render module, for displaying the webpage according to the webpage layout and the render objects of the webpage content data.

The apparatus for loading webpage content of a WebKit browser of the present disclosure further includes: a first inquiry module, electrically connected to the network module, for sending an inquiry to the network module during a layout process to determine whether the network module is downloading the webpage content data; and when the network module is downloading the webpage content data, prompting the parse module to continue parsing the webpage content data and prompting the first constructing module to continue generating the nodes of the DOM tree until the nodes contained by the DOM tree are generated.

In the apparatus for loading webpage content of a WebKit browser of the present disclosure, each time the layout process is completed, the first inquiry module sends an inquiry to the network module to determine whether the network module is downloading the webpage content data. When the network module is downloading the webpage content data, the first inquiry module prompts the parse module to continue parsing the webpage content data and prompts the first constructing module to continue generating the nodes of the DOM tree until the nodes contained by the DOM tree are generated.

The apparatus for loading webpage content of a WebKit browser of the present disclosure further includes: a first inquiry module, electrically connected to the network module, for sending an inquiry to the network module during the webpage layout process to determine whether the network module is downloading the webpage content data; and prompting the layout module to perform the webpage layout of next webpage content data when it is determined the network module is not downloading the webpage content data.

In the apparatus for loading webpage content of a WebKit browser of the present disclosure, each time a layout is completed, the first inquiry module sends an inquiry to the network module to determine whether the network module is downloading the webpage content data. When the network module is not downloading the webpage content data, the first inquiry module prompts the layout module to perform the layout process for next webpage content data.

The apparatus for loading webpage content of a WebKit browser of the present disclosure further includes: a second inquiry module, electrically connected to the network module, for sending an inquiry to the network module during the render process of obtaining the render objects to determine whether the network module is downloading the webpage content data; and when the network module is downloading the webpage content data, prompting the parse module to continue parsing the webpage and prompting the first constructing module to continue generating the nodes of the DOM tree until all the nodes contained by the DOM tree are generated.

In the apparatus for loading webpage content of a WebKit browser of the present disclosure, each time after an objected is rendered, the second inquiry module sends an inquiry to the network module to determine whether the network module is downloading the webpage content data. When the network module is downloading the webpage content data, the second inquiry module prompts the parse module to continue parsing the webpage content data and prompts the first constructing module to continue generating the nodes of the DOM tree until the nodes contained by the DOM tree are generated.

The apparatus for loading webpage content of a WebKit browser of the present disclosure further includes: a second inquiry module, electrically connected to the network module, for sending an inquiry to the network module during the render process of obtaining the render objects to determine whether the network module is downloading the webpage content data; and prompting the render module to render a next object when the network module is not downloading the webpage content data.

In the apparatus for loading webpage content of a WebKit browser of the present disclosure, the download module includes: a download request module, for sending to a server a request for downloading the webpage content data, and receiving the webpage content data transmitted from the server in response to the request.

As previously stated, in the conventional method, the WebKit browser constructs a render tree while constructing a DOM tree from parsed data, such that network resources are persistently occupied to slow down not only a download speed the network module but also a loading speed of webpage content. In contrast, in the step of constructing the render tree by the WebKit browser of the present disclosure, the render tree is only constructed after the DOM tree is fully constructed. That is to say, the process of constructing the render tree is performed independently to release network resources. Consequently, an overall time needed for loading the webpage with rich and complex content is reduced and the loading speed is thus increased to enhance user experiences in webpage browsing.

The disclosed techniques and implementations of the disclosed subject matter and the functional operations described in this specification may be implemented in digital electronic circuitry, or in computer software, firmware, or hardware, including the structures disclosed in this specification and any their structural equivalents, or in combinations of one or more of them. Implementations of the subject matter described in this specification can be implemented as one or more computer program products, i.e., one or more modules of computer program instructions encoded on a computer readable medium for execution by, or to control operation of, data processing apparatuses. The computer readable medium can be a machine-readable storage device, a machine-readable storage substrate, a memory device, a composition of matter effecting a machine-readable propagated signal (a machine-generated electrical, optical, or electromagnetic signal encoding information for transmission to suitable receiver apparatuses), or a combination of one or more of these things. The term “data processing apparatus” encompasses all apparatus, devices, and machines for processing data, including by way of example a programmable processor, a computer, or multiple processors or computers.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flowchart of a conventional browser constructing a DOM tree and a render tree.

FIG. 2 is a flowchart of a method of loading webpage content according to an embodiment of the present disclosure.

FIG. 3 is a flowchart of constructing a DOM tree and a render tree by a WebKit browser device implementing the method of loading webpage content according to an embodiment of the present disclosure.

FIG. 4 is a schematic diagram of a WebKit browser device implementing the method of loading webpage content according to a first embodiment of the present disclosure.

FIG. 5 is a schematic diagram of a WebKit browser device implementing the method of loading webpage content according to a second embodiment of the present disclosure.

FIG. 6 is a schematic diagram of a WebKit browser device implementing the method of loading webpage content according to a third embodiment of the present disclosure.

FIG. 7 is a schematic diagram of inquiring the network module during a layout process in the WebKit browser device according to the second embodiment of the present disclosure.

FIG. 8 is a schematic diagram of inquiring the network module during a render process in the WebKit browser device according to a third embodiment of the present disclosure.

### DETAILED DESCRIPTION OF THE PREFERRED EMBODIMENTS

The above and other aspects of the invention will become better understood with regard to the following detailed description of the preferred but non-limiting embodiments.

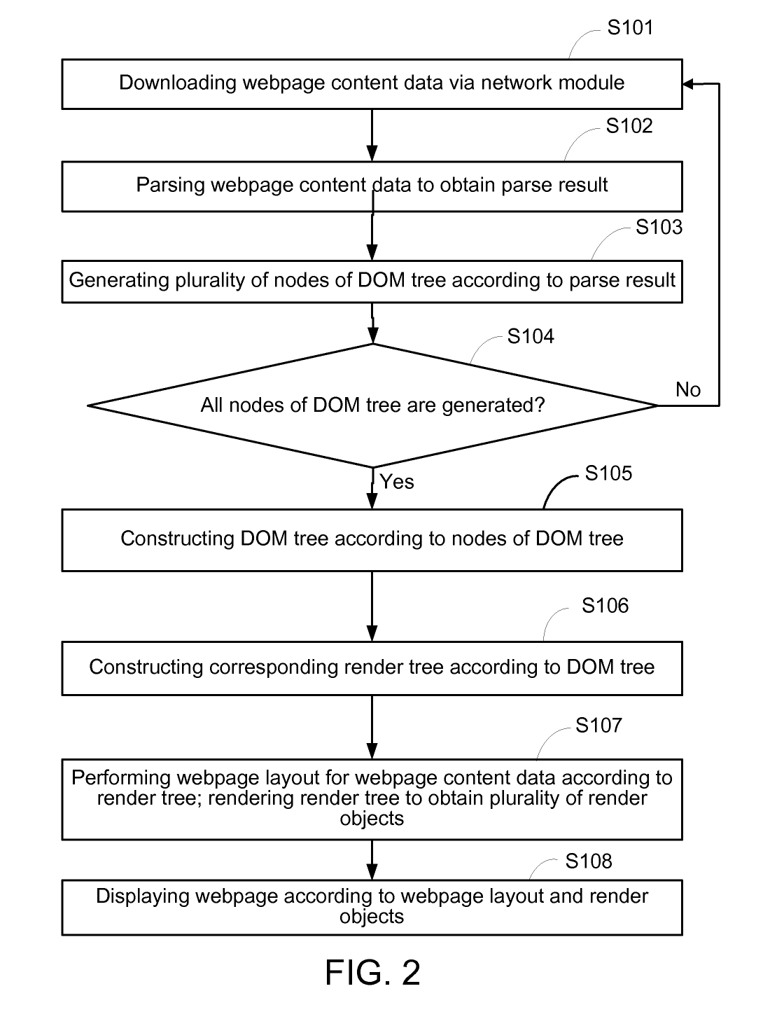

FIG. 2 shows a flowchart of a method of loading webpage content for a WebKit browser according to a preferred embodiment of the present disclosure. Steps of the method shall be described in detail below.

In Step S101, content data of a webpage is downloaded via a network module of a WebKit browser. When the WebKit browser operates to download a webpage, a browser client end sends a request to a server via the network module. In response to the request, the server accepts the request, processes data, and sends the webpage content data to the client end.

In Step S102, the data content data of the webpage is parsed to obtain a parse result. During operations of the WebKit browser, the network module receives the replied content data of the webpage and transmits the webpage content data via a callback function to a parse module. The parse module parses the webpage content data to obtain the parse result.

In Step S103, a plurality of nodes of a Document Object Model (DOM) tree are generated according to the parse result. In Step S104, it is determined whether all the nodes of the DOM tree are generated. A next step is performed when all the nodes of the DOM tree are generated, or else Steps S101 to S103 are iterated until all the nodes of the DOM tree are generated.

During operations of the WebKit browser, the parse module generates the nodes of the DOM tree according to the parse result, the network module only receives a next set of data when the parse module completes parsing a current set of data.

In Step S105, the DOM tree is constructed according to the nodes of the DOM tree. In Step S106, a corresponding render tree is constructed according to the DOM tree. It should be noted that, in Step S106, the construction of the render tree is separated from the parse module, and the corresponding render tree is constructed according to the constructed DOM tree only when the construction of the DOM tree is complete.

In Step S107, a webpage layout is performed on the webpage content data according to the render tree, and the render tree is rendered to obtain a plurality of render objects.

In a conventional WebKit browser, after the webpage is parsed, the webpage layout for the webpage content data needs to be completed before rendering. However, the webpage layout process of the webpage content having a large amount of content usually requires a significant time period, such that data arriving/having arrived via the network module may not be timely handled and undesirably affecting subsequent processing of the network module and associated data.

Similarly, in the WebKit browser, the render module needs an increased processing period since graphic processing is involved. In general, the number of elements that require rendering increases as the webpage gets more complex and the content gets richer. Thus, the browser correspondingly needs a long period for the rendering process before being presenting the webpage, and so the data of the network module may not receive timely responses and undesirably affect subsequent processing of the network module.

According to a preferred embodiment of the present disclosure, the parse module is designed as an independent unit for parsing the webpage content data. Therefore, network resources are left unoccupied when generating the nodes of the DOM tree to allow the network module to more quickly receive responses, so that the browser is able to more quickly load the webpage content.

In Step S108, the webpage is displayed by the WebKit browser according to the webpage layout and the render objects. That is, during operations of the WebKit browser, the webpage is displayed according to the webpage layout and the render objects of the webpage content after the webpage layout and the render objects are provided.

The conventional technique of DOM and render tree generation and the method according to a preferred embodiment of the present disclosure shall be compared below.

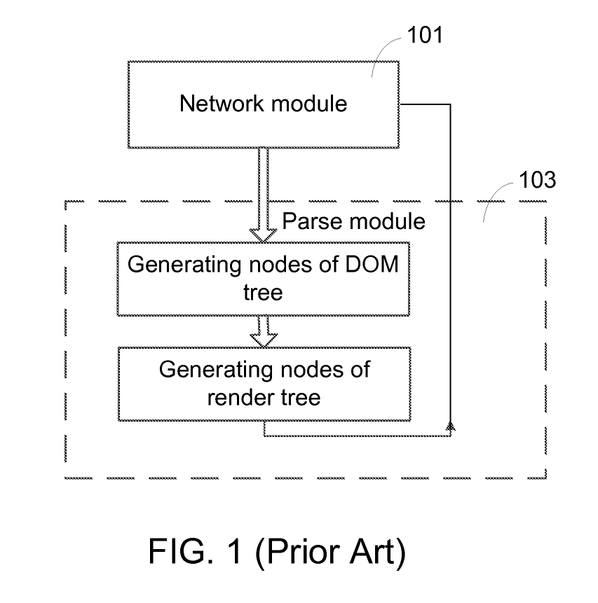

In the conventional technique of DOM and render tree generation (shown in FIG. 1), the parse module not only generates the nodes of the DOM tree according to the parse result of the webpage content data, but also generates or adjusts corresponding Cascading Style Sheets (CSS) data according to the nodes of the corresponding render tree to be constructed each time a node of the DOM tree is generated.

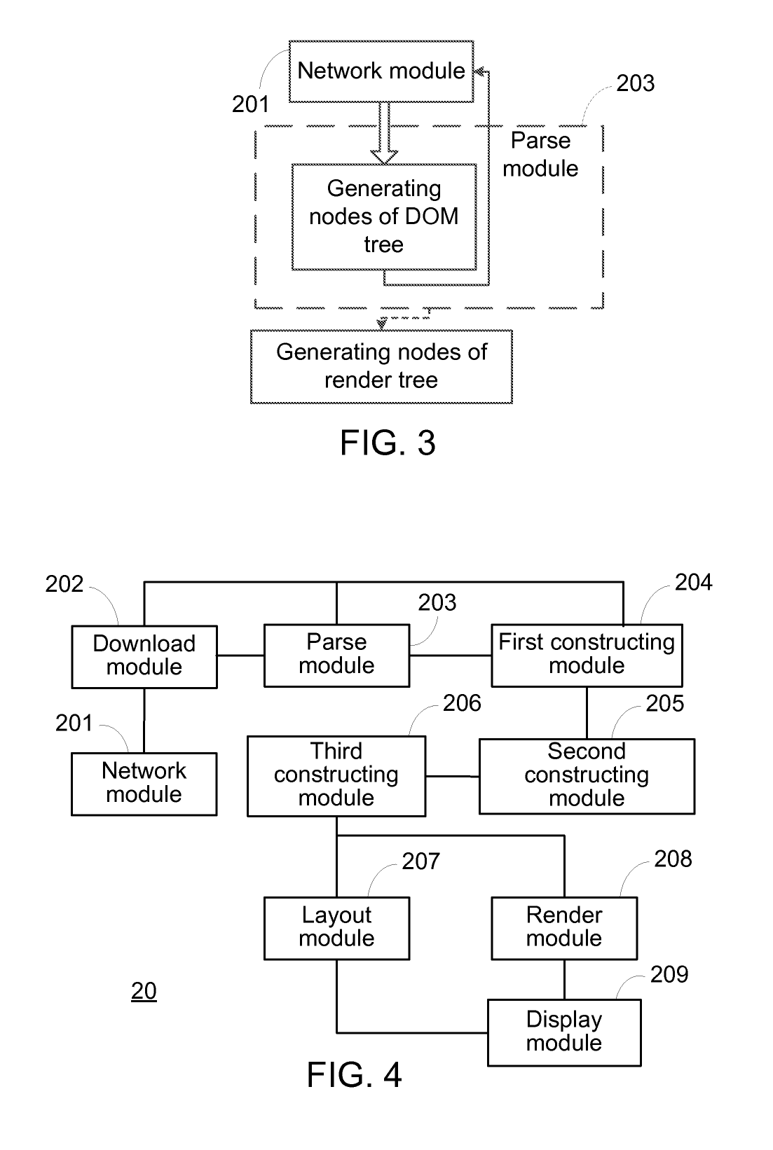

In contrast, according to an embodiment of the present disclosure, in the process of the browser constructing the DOM tree and the render tree as shown in FIG. 3, the WebKit browser does not generate the nodes of the render tree at the same time when constructing the DOM tree according to the parsed webpage content data. More specifically, the render tree is only constructed after the DOM tree is fully constructed. Therefore, by separating the construction of the render tree from the construction of the DOM tree, network resources are left unoccupied, so that an overall time needed for loading the webpage with rich and complex content is reduced and the loading speed is thus increased to enhance user experiences in webpage browsing.

Feasibility and advantages of the approach of the separate construction for the render tree shall be given below.

First of all, since a DOM tree is a type of description module that a browser utilizes to present a webpage and contains sufficient information for constructing a render tree, the construction for a render tree may be separated and processed independently provided that the DOM tree is fully constructed.

Next, contributed by the separated and independent construction of the render tree, complicity of the parse module is reduced to meanwhile shorten a processing time of the parse module. Hence, parsing of webpage content data and construction of the DOM tree may be more quickly completed to increase the speed of loading the webpage content.

Further, the callback function time of the network module is decreased to increase the download speed for replying to other network resources.

FIG. 4 shows an apparatus implementing the method of loading webpage content according to a first preferred embodiment of the present disclosure. An apparatus 20 for loading webpage content of a WebKit browser includes a network module 201, a download module 202, a parse module 203, a first constructing module 204, a second constructing module 205, a third constructing module 206, a layout module 207, a render module 208, and a display module 209.

Referring to FIG. 4, the download module 202, the parse module 203, and the first constructing module 204 are electrically connected to one another; the network module 201 is electrically connected to the download module 202; the second constructing module 205 is electrically connected to the first constructing module 204 and the third constructing module 206; the render module 208 and the layout module 207 are electrically connected to the third constructing module 206 and the display module 209. Functions of the modules shall be given below.

The network module 201 performs network data communication between a WebKit browser client end and a server. The download module 202 downloads webpage content data via the network module 201. The parse module 203 parses the webpage content data to obtain a parse result.

The first constructing module 204 generates nodes of a DOM tree according to the parse result, and prompts the download module 202 to continue downloading the webpage content data and the parse module 203 to parse the webpage content data. The first constructing module 204 continues generating the nodes of the DOM tree until all the nodes of the DOM tree are generated. The second constructing module 205 constructs the DOM tree according to the nodes of the DOM tree. The third constructing module 206 constructs a corresponding render tree according to the DOM tree.

The layout module 207 performs a webpage layout on the webpage content according to the render tree. The render module 208 performs a webpage rendering to obtain render objects according to the render tree. The display module 209 displays the webpage according to the webpage layout and the render objects of the webpage content.

In the conventional WebKit browser, the render tree is constructed at the same time as the DOM tree is constructed according to the parse result, such that network resources are persistently occupied causing slower speed in loading the webpage content. In contrast, according to an embodiment of the present disclosure, in the step of constructing the render tree, the render tree is only constructed after the DOM tree is fully constructed. Therefore, by separating the construction of the render tree from the construction of the DOM tree, network resources are left unoccupied, so that an overall time needed for loading the webpage with rich and complex content is reduced and the loading speed is thus increased to enhance user experiences in webpage browsing.

In the above embodiment, the download module 202 may include a download request unit and a data receiving unit. The download request unit sends to the server a request for downloading the webpage content data; the data receiving unit receives the webpage content data transmitted from the server in response to the request.

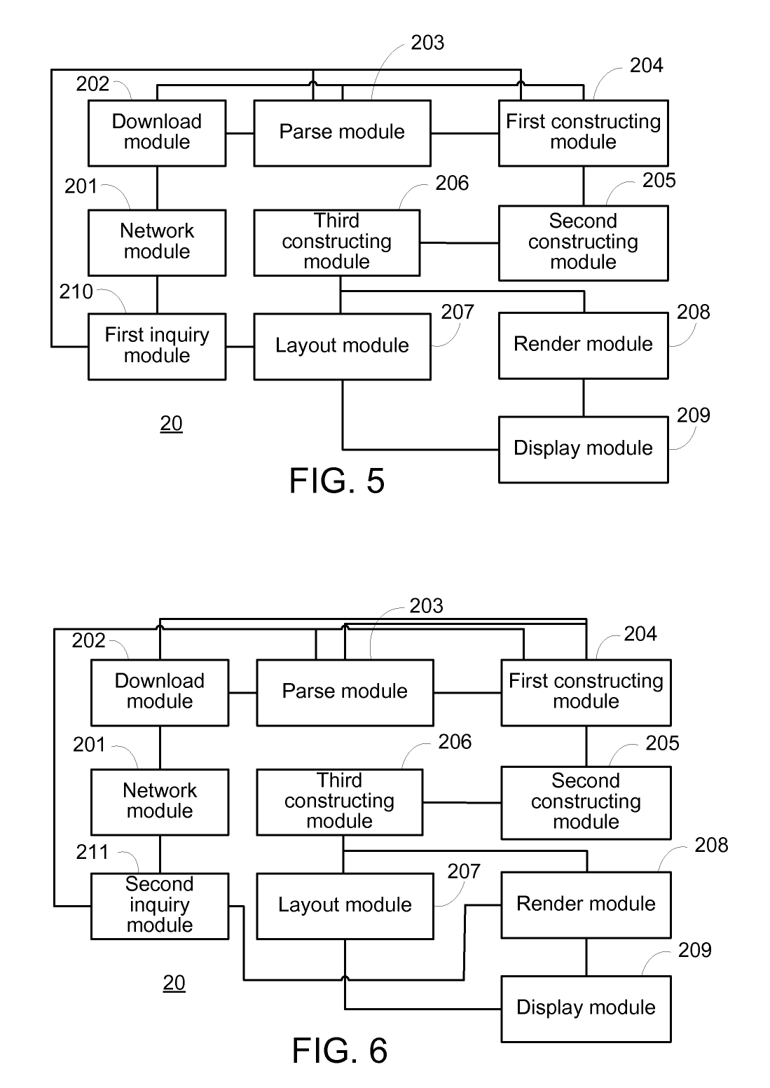

FIG. 5 shows a schematic diagram of an apparatus for loading webpage content of a WebKit browser according to a second preferred embodiment of the present disclosure. In this embodiment, the apparatus further includes a first inquiry module 210 electrically connected to the parse module 203, the first constructing module 204, and the layout module 207. The first inquiry module 210 sends an inquiry to the network module 201 during a process of webpage layout to determine whether the network module 201 is downloading the webpage content data. When it is determined that the network module 201 is downloading the webpage content data, the first inquiry module 210 prompts the parse module 203 to continue parsing the webpage content data and prompts the first constructing module 204 to continue generating the nodes of the DOM tree until all the nodes of the DOM tree are generated. When it is determined that the network module 201 is not downloading the webpage content data, the first inquiry module 210 prompts the layout module 207 to perform the webpage layout for the next webpage content.

FIG. 6 shows a schematic diagram of an apparatus for loading webpage content of a WebKit browser according to a third preferred embodiment of the present disclosure. In this embodiment, the apparatus 20 further includes a second inquiry module 211 electrically connected to the parse module 203, first constructing module 204, and the render module 208. During a process of rendering for obtaining the render objects, the second inquiry module 211 sends an inquiry to the network module 210 to determine whether the network module 201 is downloading the webpage content data. When it is determined that the network module 201 is downloading the webpage content data, the second inquiry module 211 prompts the parse module 203 to continue parsing the webpage content data and prompts the first constructing module 204 to continue generating the nodes of the DOM tree until all the nodes of the DOM tree are generated. When it is determined that the network module 201 is not downloading the webpage content data, the second inquiry module 211 prompts the render module 208 to render a next object.

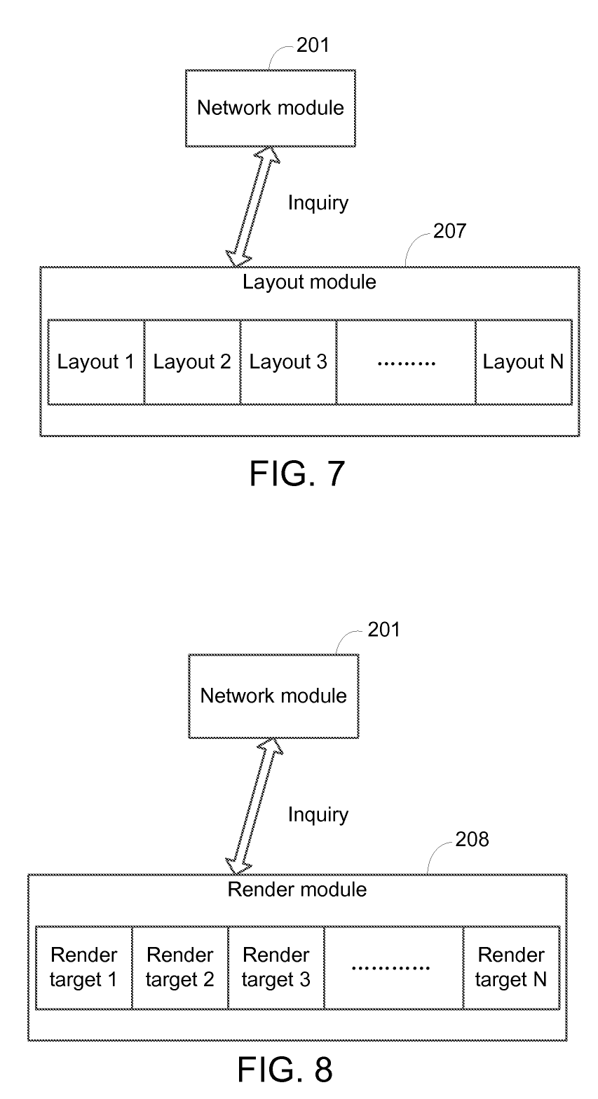

FIG. 7 shows a schematic diagram of inquiring the network module during the layout process in the apparatus for loading webpage content of a WebKit browser according to a second embodiment of the present disclosure. It is seen from the diagram that, when performing the webpage layout, the layout module 207 inquires the network module 201 whether the webpage content is to be downloaded. If an inquiry result is affirmative, the layout module 207 performs the layout process for a layout 1, a layout 2, . . . , and a layout N according to the received webpage content.

That is to say, a design of inquiring the network module 201 whether the network module 201 is downloading the webpage content data is added to the process of webpage layout. When the inquiry result is affirmative, the parse module 203 continues parsing the webpage content data, and the first constructing module 204 continues generating the nodes of the DOM tree until all the nodes of the DOM tree are generated.

Alternatively, an inquiry may also be sent to the network module 201 each time a layout is completed to determine whether the network module 201 is downloading the webpage content data. When the inquiry result is affirmative, the parse module 203 continues parsing the webpage content data, and the first constructing module 204 continues generating the nodes of the DOM tree until all the nodes of the DOM tree are generated. When the inquiry result is negative, the layout module 207 performs the webpage layout for next webpage content.

FIG. 8 shows a schematic diagram of inquiring the network module during the render process in the apparatus for loading webpage content of a WebKit browser according to a third embodiment of the present disclosure. It is seen from the diagram that, when performing the render process, the render module 208 inquires the network module 201 whether the webpage content is to be downloaded. If an inquiry result is affirmative, the render module 208 renders a render target 1, a render target 2, . . . , and a render target N according to the received webpage content.

That is to say, a design of inquiring the network module 201 whether the network module 201 is downloading the webpage content data is added to the render process. When the inquiry result is affirmative, the parse module 203 continues parsing the webpage content data, and the first constructing module 204 continues generating the nodes of the DOM tree until all the nodes of the DOM tree are generated.

Alternatively, an inquiry may also be sent to the network module 201 each time an object is rendered to determine whether the network module 201 is downloading the webpage content data. When the inquiry result is affirmative, the parse module 203 continues parsing the webpage content data, and the first constructing module 204 continues generating the nodes of the DOM tree until all the nodes of the DOM tree are generated. When the inquiry result is negative, the render module 208 renders a next object.

With the above embodiments, it is illustrated that the method and apparatus of the present disclosure are capable of effectively reducing a waiting time caused by untimely processing data received at the network module. Thus, the network module is allowed to reply more quickly and thus the browser is enabled to operate more spontaneously to shorten an overall time needed for loading webpage resources, thereby significantly optimizing performance of the network module and reducing delays caused by untimely processing. Further, by optimizing the performance of the network module, the server is allowed to acquire network resources at a faster speed so that other modules in the browser can process data at a greater speed to provide a WebKit browser engine with a faster speed in loading network resources.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of loading webpage content, applied to a WebKit browser, comprising:
downloading content data of a webpage via a network module;
parsing the content data of the webpage to obtain a parse result;
generating a plurality of nodes of a Document Object Model (DOM) tree according to the parse result;
constructing the DOM tree according to the nodes of the DOM tree;
constructing a corresponding render tree according to the DOM tree;
performing a webpage layout for the content data of the webpage according to the render tree, and rendering the render tree to obtain a render object; and
displaying the webpage according to the webpage layout and the render object.

2. The method according to claim 1, wherein the step of performing the webpage layout for the content data of the webpage according to the render tree comprises:
performing the webpage layout for the content data of the webpage according to the render tree, and sending an inquiry to the network module during a layout process to determine whether the network module is downloading the content data of the webpage;
continuing the parsing the content data of the webpage when the network module is downloading the content data of the webpage; and
generating the nodes of the DOM tree until all the nodes of the DOM tree are generated.

3. The method according to claim 2, wherein the step of sending the inquiry to the network module during the layout process to determine whether the network module is downloading the content data of the webpage comprises:
sending the inquiry to the network module each time a layout is completed to determine whether the network module is downloading the content data of the webpage.

4. The method according to claim 1, wherein the step of performing the webpage layout for the content data of the webpage according to the render tree comprises:
performing the webpage layout for the content data of the webpage according to the render tree, and sending an inquiry to the network module during a layout process to determine whether the network module is downloading the content data of the webpage; and
when the network module is not downloading the content data of the webpage, performing the webpage layout for content data of a next webpage.

5. The method according to claim 4, wherein the step of sending the inquiry to the network module during the layout process to determine whether the network module is downloading the content data of the webpage comprises:
sending the inquiry to the network module each time a layout is completed to determine whether the network module is downloading the content data of the webpage.

6. The method according to claim 1, wherein the step of rendering the render tree to obtain the render object comprises:
rendering the render tree to obtain the render object, and sending an inquiry to the network module during a render process to determine whether the network module is downloading the content data of the webpage; and
when the network module is downloading the content data of the webpage, continuing parsing the content data of the webpage, and generating the nodes of the DOM tree until all the nodes of the DOM tree are generated.

7. The method according to claim 6, wherein the step of sending the inquiry to the network module during the render process to determine whether the network module is downloading the content data of the webpage comprises:
sending the inquiry to the network module each time a layout is completed to determine whether the network module is downloading the content data of the webpage.

8. The method according to claim 1, wherein the step of rendering the render tree to obtain the render object comprises:
rendering the render tree to obtain the render object, and sending an inquiry to the network module during a render process to determine whether the network module is downloading the content data of the webpage; and
rendering a next object when the network module is not downloading the content data of the webpage.

9. The method according to claim 8, wherein the step of sending the inquiry to the network module during the render process to determine whether the network module is downloading the content data of the webpage comprises:
sending the inquiry to the network module each time the render process for an object is completed determine whether the network module is downloading the content data of the webpage.

10. The method according to claim 1, wherein the step of downloading the content data of the webpage comprises:
sending to a server a request for downloading the content data of the webpage; and
receiving the content data of the webpage transmitted by the server in response to the request.

11. An apparatus for loading webpage content of a WebKit browser, comprising:
a network module, for performing network data communication between a client end and a server;
a download module, electrically connected to the network module, for downloading content data of a webpage via the network module;
a parse module, electrically connected to the download module, for parsing the content data of the webpage to obtain a parse result;
a first constructing module, electrically connected to the parse module, for generating a plurality of nodes of a DOM tree according to the parse result;
a second constructing module, electrically connected to the first constructing module, for constructing the DOM tree according to the nodes of the DOM tree;
a third constructing module, electrically connected to the second constructing module, for constructing a corresponding render tree according to the DOM tree;
a layout module, electrically connected to the third constructing module, for performing a webpage layout for the content data of the webpage according to the render tree;
a render module, electrically connected to the third constructing module, for rendering the render tree to obtain a plurality of render objects; and
a display module, electrically connected to the render module, for displaying the webpage according to the webpage layout and the render objects.

12. The apparatus for loading webpage content of a WebKit browser according to claim 11, further comprising:
a first inquiry module, electrically connected to the network module, for sending an inquiry to the network module during a layout process to determine whether the network module is downloading the webpage content data; and when the network module is downloading the webpage content data, prompting the parse module to continue parsing the webpage content data and the first constructing module to continue generating the nodes of the DOM tree until the nodes contained in the DOM tree generated.

13. The apparatus for loading webpage content of a WebKit browser according to claim 12, wherein:
each time the first inquiry completes a layout, the first inquiry module sends an inquiry to the network module to determine whether the network module is downloading the webpage content data; and
prompting the parse module by the first inquiry module to continue parsing the webpage content data and prompting the first constructing module to continue generating the nodes of the DOM tree until the nodes contained by the DOM tree are generated when it is determined that the network module is downloading the webpage content data, the first inquiry module prompts.

14. The apparatus for loading webpage content of a WebKit browser according to claim 11, further comprising:
a first inquiry module, electrically connected to the network module, for sending an inquiry to the network module during a layout process to determine whether the network module is downloading the webpage content data; and
prompting the layout module to perform the webpage layout of content data of a next webpage when the network module is not downloading the webpage content data.

15. The apparatus for loading webpage content of a WebKit browser according to claim 14, wherein each time the first inquiry completes a layout, the first inquiry module sends an inquiry to the network module to determine whether the network module is downloading the webpage content data; when the network module is downloading the webpage content data, the first inquiry module prompts the layout module to perform the webpage layout of content data of a next webpage.

16. The apparatus for loading webpage content of a WebKit browser according to claim 11, further comprising:
a second inquiry module, electrically connected to the network module, for sending an inquiry to the network module during a render process of obtaining the render objects to determine whether the network module is downloading the webpage content data; and when the network module is downloading the webpage content data, prompting the parse module to continue parsing the webpage content data and prompting the first constructing module to continue generating the nodes of the DOM tree until the nodes contained by the DOM tree are generated.

17. The apparatus for loading webpage content of a WebKit browser according to claim 16, wherein each time the render process for an object is completed, the second inquiry module sends an inquiry to the network module to determine whether the network module is downloading the webpage content data; when the network module is downloading the webpage content data, the first inquiry module prompts the parse module to continue parsing the webpage content data and prompts the first constructing module to continue generating the nodes of the DOM tree until the nodes contained by the DOM tree are generated.

18. The apparatus for loading webpage content of a WebKit browser according to claim 11, further comprising:
a second inquiry module, electrically connected to the network module, for sending an inquiry to the network module during a render process of obtaining the render objects to determine whether the network module is downloading the webpage content data; and when the network module is not downloading the content data of the webpage, prompting the render module to render a next object.

19. The apparatus for loading webpage content of a WebKit browser according to claim 18, wherein each time the render process for an object is completed, the second inquiry module sends an inquiry to the network module to determine whether the network module is downloading the webpage content data; and the second inquiry module prompts the render module to render a next object when the network module is not downloading the content data of the webpage.

20. The apparatus for loading webpage content of a WebKit browser according to claim 11, wherein the download module comprises:
a download request unit, for sending to the server a request for downloading the webpage content data; and a data receiving unit, for receiving the webpage content data transmitted from the server in response to the request.
